(19) United States
(12) Patent Application Publication
(10) Pub. No.: US 2015/0354513 A1
(43) Pub. Date: Dec. 10, 2015

(54) Resonator Apparatus for Vehicles

(71) Applicant: Hyundai Motor Company, Seoul (KR)

(72) Inventor: Teock Hyeong CHO, Seoul (KR)

(73) Assignee: Hyundai Motor Company, Seoul (KR)

(21) Appl. No.: 14/522,450

(22) Filed: Oct. 23, 2014

(30) Foreign Application Priority Data
Jun. 5, 2014 (KR) 10-2014-0068245

(51) Int. Cl. F02M 35/12

(52) U.S. Cl. CPC F02M 35/1255

(57) ABSTRACT

A resonator apparatus for vehicles may include a housing configured to have a pipe shape and be disposed in an air passage to have air penetrating thereinto, a first baffle configured to have a pipe shape, be inserted into the housing, have an inner diameter smaller than an inner diameter of the housing, and be slidable in a length direction of the housing, and a second baffle configured to have a pipe shape, be inserted into the housing, have an inner diameter smaller than an inner diameter of the housing, be slidable in the length direction of the housing, and be spaced apart from the first baffle by a predetermined distance.

### CROSS REFERENCE TO RELATED APPLICATION

The present application claims priority to Korean Patent Application No. 10-2014-0068245, filed on Jun. 5, 2014, the entire contents of which is incorporated herein for all purposes by this reference.

### BACKGROUND OF THE INVENTION

1. Field of the Invention

The present invention relates to a resonator apparatus for vehicles which is disposed in an air passage of a vehicle to be able to reduce flow noises generated in response to an engine RPM.

2. Description of Related Art

Generally, an intake apparatus for a vehicle directly affects an output of an engine of a vehicle and is configured to include an air cleaner which sucks air from the outside to filter impurities, an intake manifold which is connected to the air cleaner to uniformly distribute air to the engine, and a suction pipe which connects the intake manifold to the air cleaner and has one side provided with an intake noise reduction apparatus.

In this configuration, the apparatus for reducing intake noise is configured to include a resonator and an extending pipe connecting between the suction pipe and the resonator and a throttle valve and a surge tank are disposed between the intake manifold and the air cleaner.

As described above, the intake apparatus for a vehicle sucks and purifies outside air through the air cleaner and uniformly distributes sucked air to a plurality of combustion chambers through the throttle valve and the surge tank.

In this configuration, vibrations due to a reciprocating motion of intake and exhaust valves of the engine and a piston and noises due to the vibrations flow backward in the suction pipe and the resonator resonates a specific frequency to remove the vibrations.

In particular, when a turbo charger is coupled with the engine, the turbo charger supercharges air in a cylinder to improve engine performance, and therefore a larger amount of air flows. However, the related art uses a single resonator apparatus to offset only flow noises within a specific engine RPM range or uses a plurality of resonator apparatuses to reduce the flow noises within the required engine RPM range, and therefore costs may be increased and a structure may be complicated.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a resonator apparatus for vehicles capable of simplifying a structure and reducing costs while reducing flow noises in a plurality of regions in response to an engine RPM.

In an aspect of the present invention, a resonator apparatus for vehicles may include a housing configured to have a pipe shape and be disposed in an air passage to have air penetrating thereinto, a first baffle configured to have a pipe shape, be inserted into the housing, may have an inner diameter smaller than an inner diameter of the housing, and be slidable in a length direction of the housing, and a second baffle configured to have a pipe shape, be inserted into the housing, may have an inner diameter smaller than an inner diameter of the housing, be slidable in the length direction of the housing, and be spaced apart from the first baffle by a predetermined distance.

The housing is provided with a guide slot formed in the length direction and the first and second baffles are respectively provided with a guide protrusion protruding outwardly in a radial direction, the protrusion being slidably engaged with the guide slot to make the guide protrusion be slid back and forth within the guide slot.

The guide slot of the housing is separately provided with a sealing member to seal the guide slot to prevent air from being leaked through the guide slot at a time of a flow of air.

The first and second baffles are provided with separate actuators to change a length between the first and second baffles by a control unit.

The first and second baffles are provided with separate operating rods to change a length between the first and second baffles due to a difference in air pressure.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating that a resonator apparatus for vehicles according to an exemplary embodiment of the present invention is mounted.

FIG. 2 is a perspective view of the resonator apparatus for vehicles.

FIG. 3A and FIG. 3B are projected views of FIG. 2, having actuator and operating rod, respectively.

FIG. 4 is a detailed view of portion A of FIG. 3A and FIG. 3B.

FIG. 5 and FIG. 6 are graphs illustrating a transmission loss within a middle RPM band and a high RPM band.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, a resonator apparatus for vehicles according to an exemplary embodiment of the present invention will be described with reference to the accompanying drawings.

A specific frequency is formed by a rotation of an engine of a vehicle and air sucked into a suction region to generate flow noises which are recognized by a passenger as noises. Generally, the resonator apparatus for vehicles is generally formed in a suction line of a vehicle and forms a unique frequency using a volume formed by a volume and a length in the resonator apparatus. Therefore, a frequency generated by the rotation of the engine and the suction is offset with a frequency formed in the resonator apparatus, which is referred to as a transmission loss of the resonator apparatus.

The transmission loss TL is a value indicating a sound isolation effect of a sound isolation material and may be represented by the following Equation using transmittance τ.

$$TL = 10 log ( \frac{1}{τ} ) [ dB ]$$

Therefore, the transmission loss is a multiple of a common logarithm of a reciprocal number of τ (transmittance) by 10, in which the higher the frequency, the better the sound isolation effect.

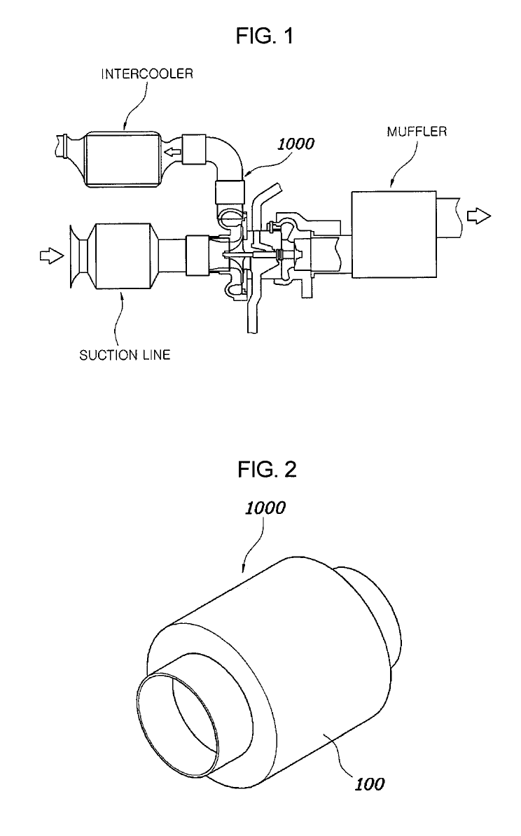

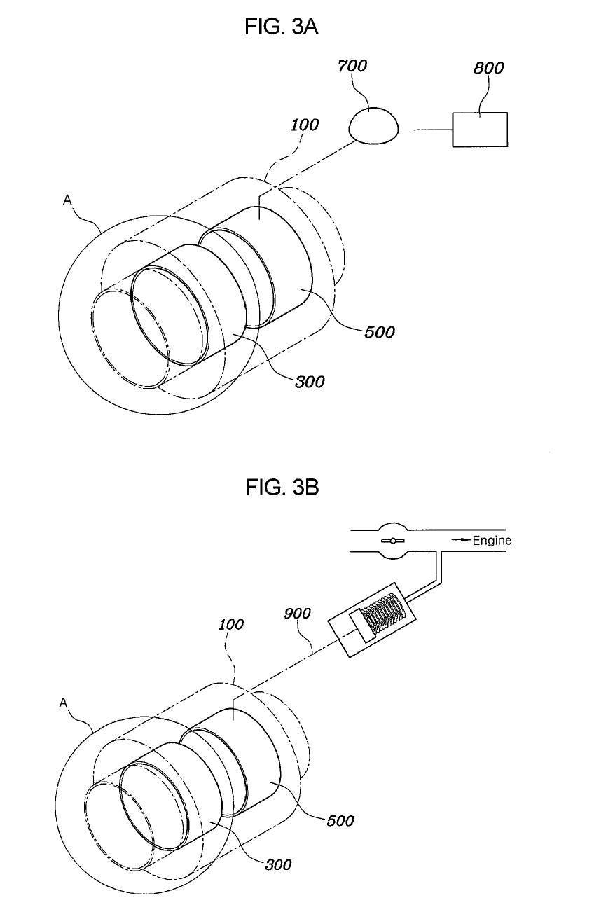

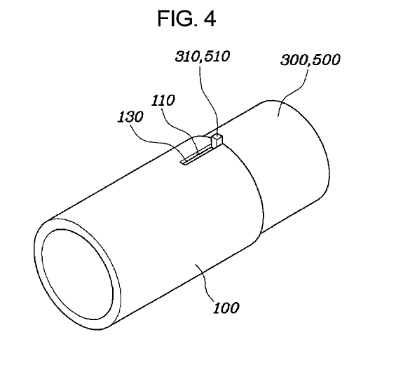

FIG. 1 is a view illustrating that a resonator apparatus 1000 for vehicles according to an exemplary embodiment of the present invention is mounted and FIG. 2 is a perspective view of the resonator apparatus 1000 for vehicles. FIGS. 3A and 3B are projected views of FIG. 2 and FIG. 4 is a detailed view of portion A of FIGS. 3A and 3B.

The resonator apparatus for vehicles according to the exemplary embodiment of the present invention is configured to include: a housing 100 configured to have a pipe shape, be disposed in an air passage to have air penetrating thereinto, a first baffle 300 configured to have a pipe shape, be inserted into the housing 100, have an inner diameter smaller than that of the housing 100, and be slid in a length direction of the housing 100, and a second baffle 500 configured to have a pipe shape, be inserted into the housing 100, have an inner diameter smaller than that of the housing 100, be slid in the length direction of the housing 100, and be spaced apart from the first baffle 300 by a predetermined distance.

The resonator apparatus for vehicles according to the exemplary embodiment of the present invention is to reduce flow noises of a turbo charger but in some cases, may also be applied to a typical intake system or exhaust system and it is to be noted that contents thereof may be changed without limitation according to design or environment. However, the exemplary embodiment of the present invention will describe a case in which the resonator apparatus is applied to the turbo charger, by way of example.

The resonator apparatus 1000 for vehicles according to the exemplary embodiment of the present invention is disposed in a middle suction pipe through which air sucked from the intake system is introduced into an intercooler. The housing 100 of the resonator apparatus for vehicles has a pipe shape which has a diameter equal to or larger than that of the suction pipe and is provided in an air passage to have air penetrating thereinto.

An inside of the housing 100 is provided with the first baffle 300 which has a pipe shape, is inserted into the housing, has an inner diameter smaller than that of the housing, and is formed to be slid in a length direction of the housing 100 and the second baffle 500 spaced apart from the first baffle 300 by a predetermined distance. The exemplary embodiment of the present invention illustrates that the first baffle 300 and the second baffle 500 are formed to have the same shape, but the size or shape of the first baffle 300 and the second baffle 500 may be changed without limitation according to the design or environment.

The first baffle 300 and the second baffle 500 in the housing 100 are configured to change a distance between the first baffle 300 and the second baffle 500 to appropriately tune a frequency so as to offset the frequencies of the flow noises from low RPM band to high RPM band of the corresponding vehicle, thereby appropriately forming a volume in the resonator apparatus 1000. The operation may be performed according to a control of a control unit.

Therefore, as described above, in order for a length between the first baffle 300 and the second baffle 500 to be accurately and smoothly changed, the housing 100 is provided with a guide slot 110 formed in a length direction, the baffles 300 and 500 are provided with guide protrusions 310 and 510 protruding outwardly in a radial direction and having a predetermined size to make the guide protrusions 310 and 510 be slid back and forth within the guide slot 110, thereby changing the volume and length of the baffles 300 and 500.

Further, the guide slot 110 of the housing 100 is separately provided with a sealing member 130 to seal the guide slot 110 and thus even though the guide protrusions 310 and 510 of the first baffle 300 and the second baffle 500 are slid back and forth within the guide slot 110 of the housing 100, the slot is formed to prevent air from being leaked through the guide slot 110 at the time of the flow of sucked air. As the sealing member 130, a sealing, and the like may be used.

The baffles 300 and 500 are separately provided with an actuator 700 and thus the length between the baffles 300 and 500 may be changed by the control unit 800 or the baffles 300 and 500 are separately provided with operating rods 900 and thus the length between the baffles 300 and 500 may be changed due to motion of the operating rods 900 in accordance with change of pressure of air to be sucked to engine in response to a change in stepped amount of an accelerator, and the like. The foregoing contents are an already known technology and therefore a separate detailed description thereof will be omitted herein.

Further, in some cases, in the housing 100, a separate support member is formed between the baffles 300 and 500 and the guide slot 110 and the sealing member 130 are formed at the support member to make the baffles 300 and 500 be slid back and forth, which may be changed without limitation according to the environment or design.

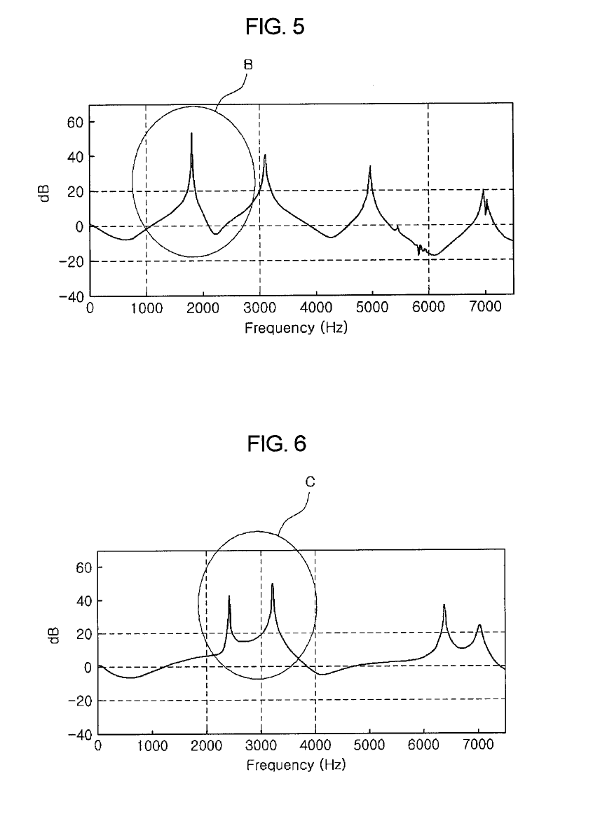

FIGS. 5 and 6 are graphs illustrating a transmission loss within a middle RPM band and a high RPM band, by way of example. An operation of the resonator apparatus for vehicles according to the exemplary embodiment of the present invention will be described in more detail with reference to FIGS. 5 and 6.

The first baffle 300 and the second baffle 500 in the housing 100 are each slid when being in the high-speed rotation range (high RPM) and the middle-speed rotation range (middle RPM) according to the engine rotation of the vehicle to change the volume within the housing 100 of the resonator apparatus 1000, thereby reducing the flow noises due to the frequency in the high RPM and the frequency in the middle RPM, respectively. In the graphs illustrated in FIGS. 5 and 6, the transmission loss may be confirmed through B and C, respectively and in particular, it may be confirmed that the flow noises between 1000 and 3500 Hz may be simultaneously reduced.

Therefore, for the foregoing behavior, the positions of the first baffle 300 and the second baffle 500 need to be changed corresponding to the rotation region of the engine and the distance between the first baffle 300 and the second baffle 500 is increased in the middle RPM to increase the overall length of the baffles 300 and 500, such that the volume formed by the baffles 300 and 500 is increased to increase the transmission loss, thereby reducing the flow noises in the middle RPM band.

Further, in the high RPM, the distance between the first baffle 300 and the second baffle 500 is reduced to reduce the overall length of the baffles 300 and 500, such that the volume formed by the baffles 300 and 500 is reduced to increase the transmission loss, thereby reducing the flow noises in the high RPM band.

Therefore, unlike the resonator apparatus according to the related art which may reduce only the flow noises within the specific frequency band at the specific RPM, according to the resonator apparatus for vehicles in accordance with the exemplary embodiment of the present invention, it is possible to reduce the flow noises of the turbo charger within the full band simultaneously by changing the length and volume of the first baffle and the second baffle in the housing so as to offset the flow noises within the specific frequency bands corresponding to each engine RPM band.

Further, since the flow noises within the full band may be offset with the single resonator apparatus without disposing the plurality of resonator apparatuses for each frequency band, the number of parts may be more reduced than the related art and therefore costs may be saved and the freedom of design may be increased. Further, the exemplary embodiments of the present invention may be applied to the turbo charger and all the components for which the resonator apparatus are required.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A resonator apparatus for vehicles, comprising:
a housing configured to have a pipe shape and be disposed in an air passage to have air penetrating thereinto;
a first baffle configured to have a pipe shape, be inserted into the housing, have an inner diameter smaller than an inner diameter of the housing, and be slidable in a length direction of the housing; and
a second baffle configured to have a pipe shape, be inserted into the housing, have an inner diameter smaller than an inner diameter of the housing, be slidable in the length direction of the housing, and be spaced apart from the first baffle by a predetermined distance.

2. The resonator apparatus for the vehicles of claim 1, wherein the housing is provided with a guide slot formed in the length direction and the first and second baffles are respectively provided with a guide protrusion protruding outwardly in a radial direction, the protrusion being slidably engaged with the guide slot to make the guide protrusion be slid back and forth within the guide slot.

3. The resonator apparatus for the vehicles of claim 2, wherein the guide slot of the housing is separately provided with a sealing member to seal the guide slot to prevent air from being leaked through the guide slot at a time of a flow of air.

4. The resonator apparatus for the vehicles of claim 2, wherein the first and second baffles are provided with separate actuators to change a length between the first and second baffles by a control unit.

5. The resonator apparatus for the vehicles of claim 2, wherein the first and second baffles are provided with separate operating rods and thus a length between the baffles is changed due to motion of the operating rods in accordance with change of pressure of air to be sucked to an engine.
